(19) United States
(12) Patent Application Publication
(10) Pub. No.: US 2025/0321798 A1
(43) Pub. Date: Oct. 16, 2025

(54) RETURN ON INVESTMENT ESTIMATIONS USING PROMPT PROCESSING UNITS

(71) Applicant: Cisco Technology, Inc., San Jose, CA (US)

(72) Inventors: Benjamin William Ryder, Lausanne (CH); Marcelo Yannuzzi, Nuvilly (CH); Arash Salarian, Chardonne (CH); Jean Andrei Diaconu, Gaillard (CH); Hervé Muyal, Gland (CH)

(73) Assignee: Cisco Technology, Inc., San Jose, CA (US)

(21) Appl. No.: 18/931,624

(22) Filed: Oct. 30, 2024

Related U.S. Application Data
(60) Provisional application No. 63/633,447, filed on Apr. 12, 2024.

(51) Int. Cl. G06F 9/50

(52) U.S. Cl. CPC G06F 9/5027

(57) ABSTRACT

In one implementation, a device may determine a classification of a task requested by a prompt for input to a language model. The device may compute, based on the classification of the task, an estimated resource utilization associated with the language model performing the task. The device may calculate a resource utilization differential between the estimated resource utilization and a resource utilization associated with another entity performing the task instead of the language model. The device may provide an indication of the resource utilization differential via a user interface.

### RELATED APPLICATION

This application claims priority to U.S. Prov. Appl. Ser. No. 63/633,447, filed Apr. 12, 2024, for RETURN ON INVESTMENT ESTIMATIONS USING PROMPT PROCESSING UNITS, by Ryder, et al., the contents of which are incorporated herein by reference.

### TECHNICAL FIELD

The present disclosure relates generally to computer networks, and, more particularly, to return on investment (ROI) estimations using prompt processing units (PPUs).

### BACKGROUND

The use of generative artificial intelligence (AI) is helping to augment productivity across enterprises. Indeed, enterprises are increasingly using pre-trained Large Language Models (LLMs) to support a myriad of enterprise tasks. These models can be hosted by third party providers and/or self-hosted. In addition, the models may be fine-tuned and/or open source. The models may be served as part of larger systems that may also include pre-integrated application programming interfaces (APIs) and/or tools to orchestrate, execute, and chain various tasks before responding to a query carried in a prompt.

Although many enterprises aim to leverage generative AI more in the near future, they face a competing aim to control computational and/or operational costs associated with its utilization. Presently, enterprises lack any mechanism by which they can achieve an understanding of whether their use of generative AI has resulted in any quantifiable gains (e.g., savings achieved by generative AI utilization versus alternative methods). For example, enterprises have no way of determining gains that may be achieved by having generative AI perform a task versus having an expert within an organization perform a given task. Consequently, there is often a hesitance within enterprises to adopt the use of generative AI given the absence of data visibility and uncertainty around resource consumption.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computing system;

FIG. 2 illustrates an example network device/node;

FIG. 3 illustrates an example of an environment for generating ROI estimations using PPUs;

FIG. 4 illustrates an example architecture including a PPU configured for generating ROI estimations using PPUs;

FIGS. 5A-5B illustrate example scenarios whereby a human expert is able to perform certain tasks at a measurable rate or within a certain amount of time;

FIG. 6 illustrates an architecture configured to generate ROI estimations using PPUs; and

FIG. 7 illustrates an example of a simplified procedure for generating PPU-based ROI estimations, in accordance with one or more implementations described herein.

### DESCRIPTION OF EXAMPLE IMPLEMENTATIONS

### Overview

According to one or more implementations of the disclosure, a device may determine a classification of a task requested by a prompt for input to a language model. The device may compute, based on the classification of the task, an estimated resource utilization associated with the language model performing the task. The device may calculate a resource utilization differential between the estimated resource utilization and a resource utilization associated with another entity performing the task instead of the language model. The device may provide an indication of the resource utilization differential via a user interface.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

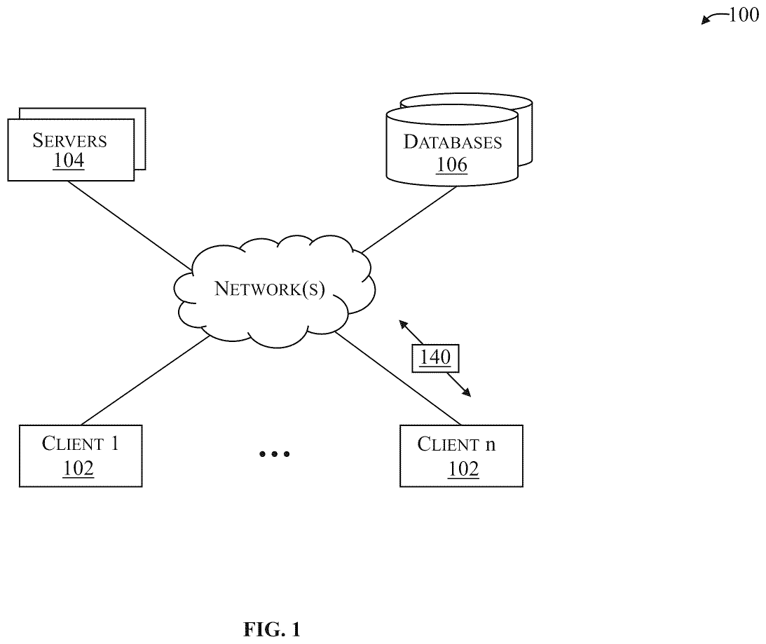

FIG. 1 is a schematic block diagram of an example simplified computing system (e.g., computing system 100) illustratively comprising any number of client devices (e.g., client devices 102 with, e.g., a first through nth client device), one or more servers (e.g., servers 104), and one or more databases (e.g., databases 106), where the devices may be in communication with one another via any number of networks (e.g., network(s) 110).

The one or more networks (e.g., network(s) 110) may include, as would be appreciated, any number of specialized networking devices such as routers, switches, access points, etc., interconnected via wired and/or wireless connections. For example, devices 102-104 and/or the intermediary devices in network(s) 110 may communicate wirelessly via links based on Wi-Fi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, servers 104 and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

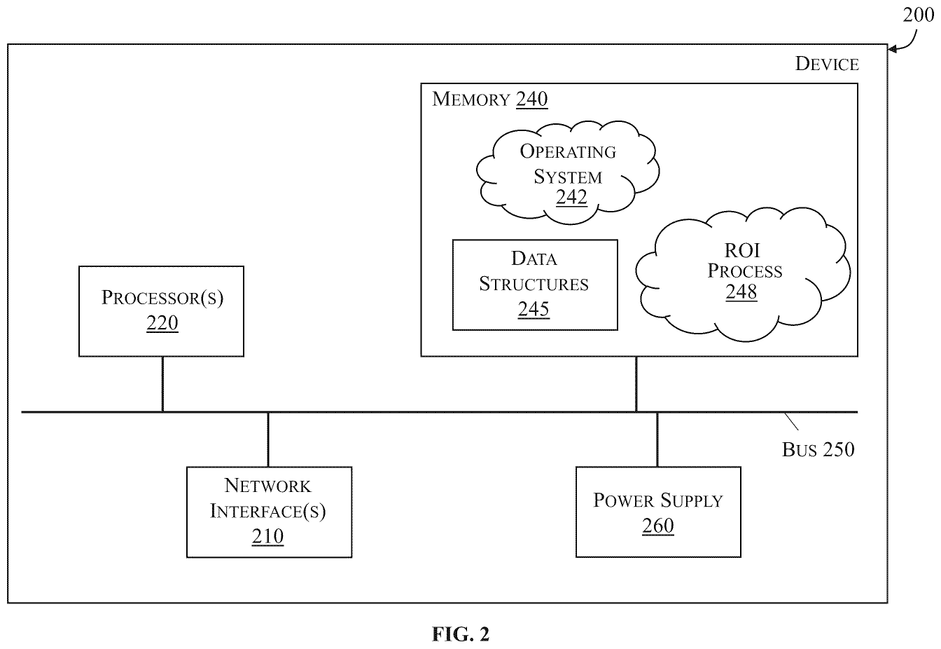

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software components and/or services may comprise a ROI process 248 as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, ROI process 248 may include computer-executable instructions that, when executed by processor(s) 220, cause device 200 to perform the techniques described herein. To do so, in some implementations, ROI process 248 may utilize non-machine learning based techniques (e.g., a look up based on the output of a PPU) and/or machine learning based techniques to generate return on investment (ROI) estimations using prompt processing units. In general, machine learning is concerned with the design and the development of techniques that take as input empirical data (such as network statistics and performance indicators) and recognize complex patterns in these data.

In various implementations, ROI process 248 may employ and/or be associated with prompt processing by one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that ROI process 248 can employ and/or be associated with prompt processing by may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, ROI process 248 may also include and/or be associated with prompt processing by one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, ROI process 248 may use and/or be associated with prompt processing by a generative model to perform a task such as explaining the top factors driving business growth, summarizing an article, etc. Example generative approaches can include, but are not limited to, generative adversarial networks (GANs), large language models (LLMs), other transformer models, and the like.

As noted above, although many enterprises aim to leverage generative AI, they lack the ability to understand whether their use of generative AI has resulted in any quantifiable gains. This may be particularly true with respect to having an expert within an organization perform a given task versus having a generative AI system perform the task instead. Without these insights, adoption and incorporation of generative AI systems within enterprises is stunted and misdirected, leading to operational inefficiency, resource misallocation, and, ultimately, impaired performance of enterprise-specific technologies whose utilization, scale, and effectiveness can be drastically accelerated and computationally transformed with the incorporation of generative AI. Alternatively, even with adoption and incorporation of generative AI systems at the enterprise level, the existing lack of insightful ROI metrics can lead to inefficient, improper, wasteful, etc. generative AI use driven by an ignorance of the actual cost and/or potential operational and/or computational losses associated with performing a task with a generative AI system as opposed to an alternative mechanism (e.g., manual performance by an expert). In short, enterprises are left without a mechanism capable of informing their decision making regarding generative AI utilization and incorporation.

### Return on Investment Estimations Using Prompt Processing Units

In contrast, the techniques described herein may leverage a prompt processing unit (PPU), which allows to characterize and distill key features from a prompt in a systematic manner in order to quantify and/or characterize, at a prompt level, ROIs and/or cost differentials between performing tasks by generative AI systems and/or alternative mechanisms. That is, the techniques introduce a mechanism by which ROI estimations (e.g., at a prompt-level) may be generated utilizing PPUs. These types of ROI insights may be utilized to improve decision making processes as they relate to generative AI utilization and/or be leveraged in decision making models tailored to enterprise-specific outcomes.

Illustratively, the techniques described herein may be performed by hardware, software, and/or firmware, such as in accordance with ROI process 248, which may include computer executable instructions executed by the processor(s) 220 (or independent processor of the network interfaces 210) to perform functions relating to the techniques described herein. Further, they may be combined with post-processing methods to provide aggregated and/or historical visibility of prompt features and insights across an enterprise.

Specifically, according to various implementations, a device may determine a classification of a task requested by a prompt for input to a language model. The device may compute, based on the classification of the task, an estimated resource utilization associated with the language model performing the task. The device may calculate a resource utilization differential between the estimated resource utilization and a resource utilization associated with another entity performing the task instead of the language model. The device may provide an indication of the resource utilization differential via a user interface.

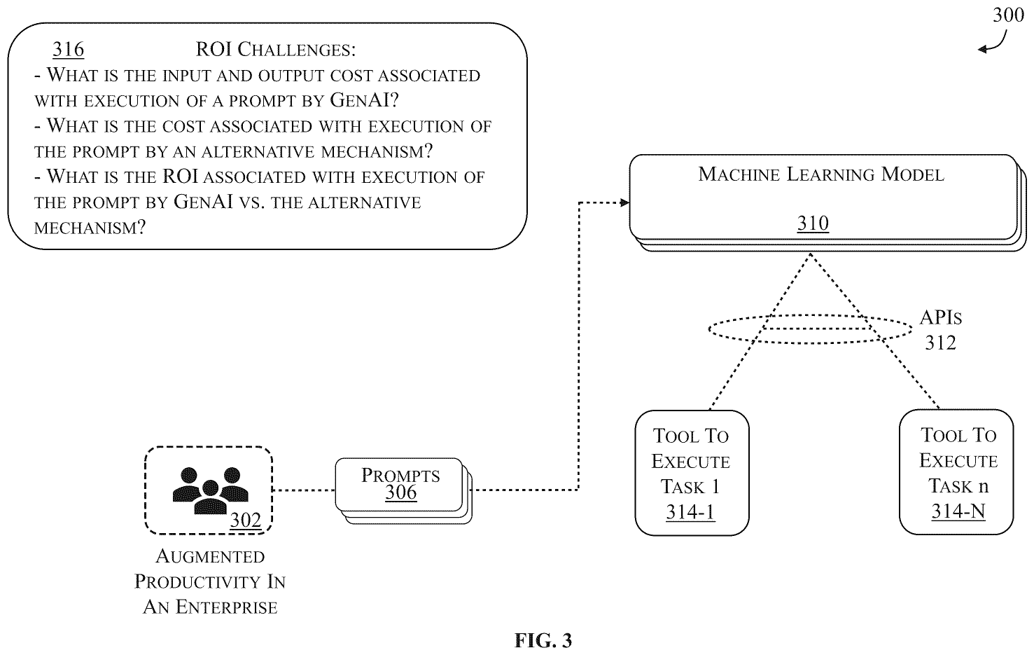

Operationally, FIG. 3 illustrates an example of an environment 300 for generating ROI estimations using PPUs, in accordance with one or more implementations described herein. In environment 300, some or all of the system may be enterprise controlled. For example, prompts 306 may be submitted (e.g., via a user chat interface or an API) within an enterprise-controlled portion of the system. The ability of users 302 to submit these prompts 306 may facilitate augmented productivity. For instance, sales, marketing, customer support, data analytics, engineering, product management, etc. may all utilize the prompts 306 to enhance their productivity.

Typically, the system may pass prompts 306 to a machine learning model 310 for processing and/or execution. For instance, machine learning model 310 may be a generative AI model, such as an LLM or other language and/or vision model. In some instances, machine learning model 310 can be hosted by third party providers and/or self-hosted. In addition, machine learning model 310 may be fine-tuned and/or open source or a public model. Machine learning model 310 may be served as part of larger systems that may also include pre-integrated application programming interfaces (APIs) and/or tools to orchestrate, execute, and chain various tasks before responding to a query carried in a prompt.

In addition, tools 314 (e.g., 314-1 . . . 314-N) for executing various tasks may be communicatively coupled (e.g., via APIs 312) to the machine learning model 310 and/or may be operable to participate in the execution of tasks specified in prompts 306.

Although many enterprises aim to leverage generative AI, they may also want to understand whether their use of generative AI has resulted in any quantifiable gains. Consequently, while the prompts 306, users 302, user/APIs 312, and/or sometimes a machine learning model 310 may be within the enterprise-controlled portion, an enterprise may be compelled to target additional understanding of how execution of the prompts 306 by generative AI translates to savings or losses in operational and/or computational costs versus executing the tasks of the prompt by alternative mechanism (e.g., manually by an expert), hence enabling them to address the challenges 316. In particular, enterprises may need techniques to semantically detect and extract the tasks from a prompt as well as from any additional context provided as part of the prompt to the machine learning model 310 (e.g., a file attached).

Machine learning model 310 and/or tools 314 may be equipped to “interpret” open-ended prompts and act upon them by generating artifacts or executing various tasks based on such “understanding.” However, this skill is not accessible to an enterprise attempting to implement ROI estimation methodologies within the enterprise-controlled portion. This lack of understanding and natural-language native techniques may hinder the observation and comprehension of what are the tasks requested, or what additional data would be involved to complete such tasks, and thus, obtaining effective ROI estimations of the prompts before, after, or during their processing by external entities.

However, these features may be enabled, and facilitated, within environment 300 utilizing prompt processing units (PPUs). Hence, environment 300 may be modified by incorporating a task control system that leverages PPUs. Such a system may be utilized to characterize and/or distill key features from prompts 306 in a systematic manner. The observability system may then leverage these characterizations to apply effective task controls before the prompts are processed by the machine learning model 310 and/or potentially by external entities.

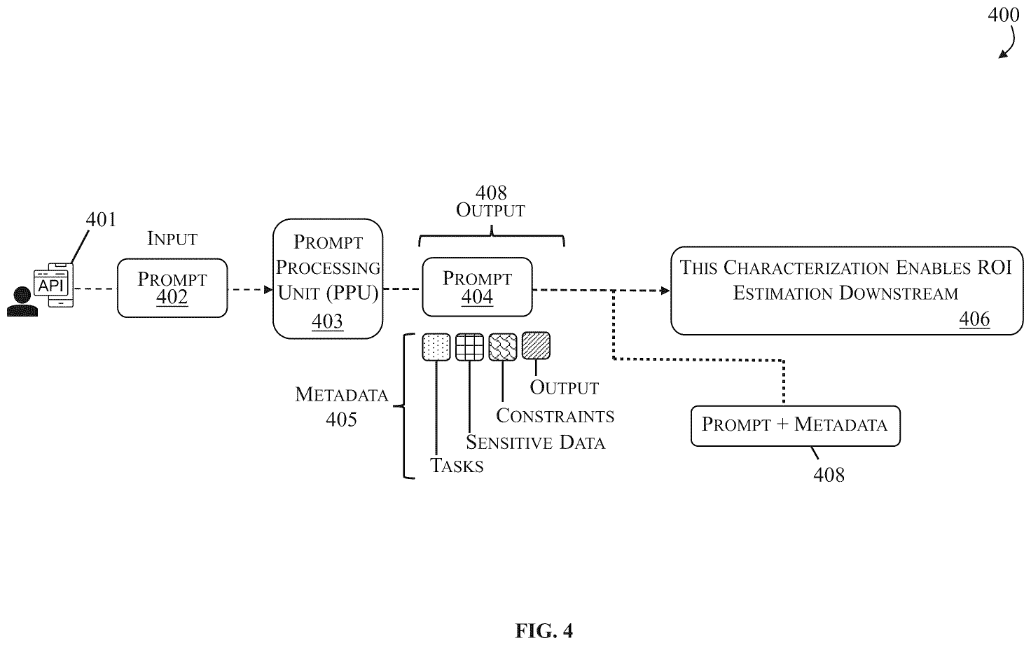

FIG. 4 illustrates an example of an architecture 400 utilizing PPUs, according to various implementations. In some instances, architecture 400 may be a portion of a data control system that leverages the outputs of PPUs to institute downstream data controls. As shown, architecture 400 includes a prompt processing unit (PPU 403). A PPU 403 may be a highly efficient processing element that may receive a prompt 402 as an input (e.g., from a user chat interface or an API 401). PPU 403 may parse the query and/or may detect a set of key features from the query. For instance, PPU 403 may detect key features within the prompt 402 such as the tasks requested, the sensitive data entailed to complete the tasks, any constraints applicable to complete the tasks, and/or the desired output upon completion of such tasks.

A PPU 403 may act as a transparent element, delivering the unmodified prompt 404 augmented with metadata 405 carrying the key features, such as those described above. More specifically, a PPU 403 may systematically distill and characterize prompts, allowing for downstream controls 406 to be applied.

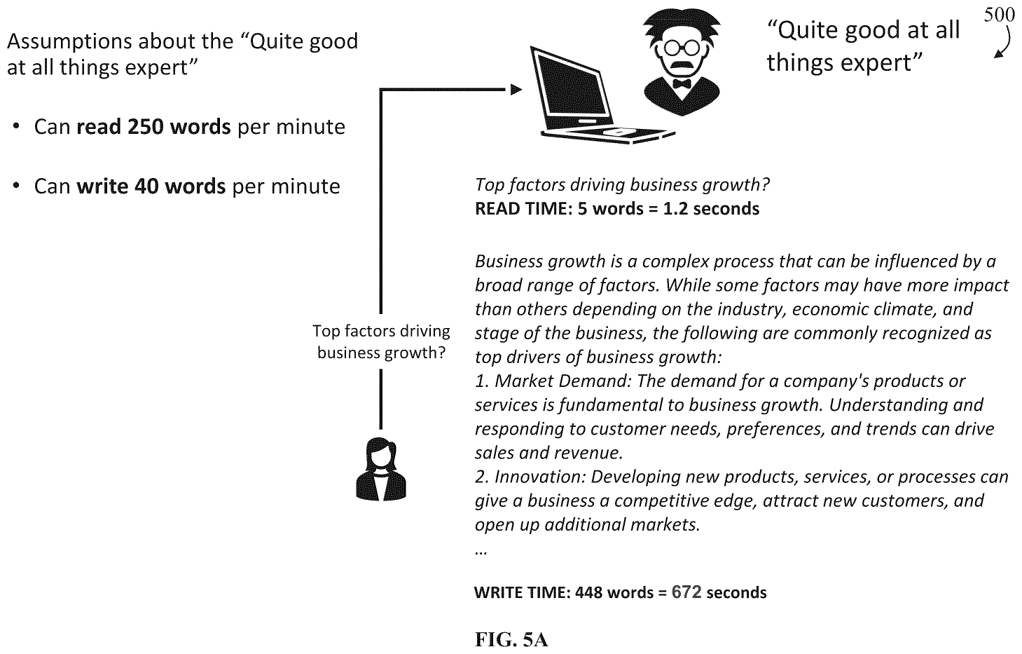

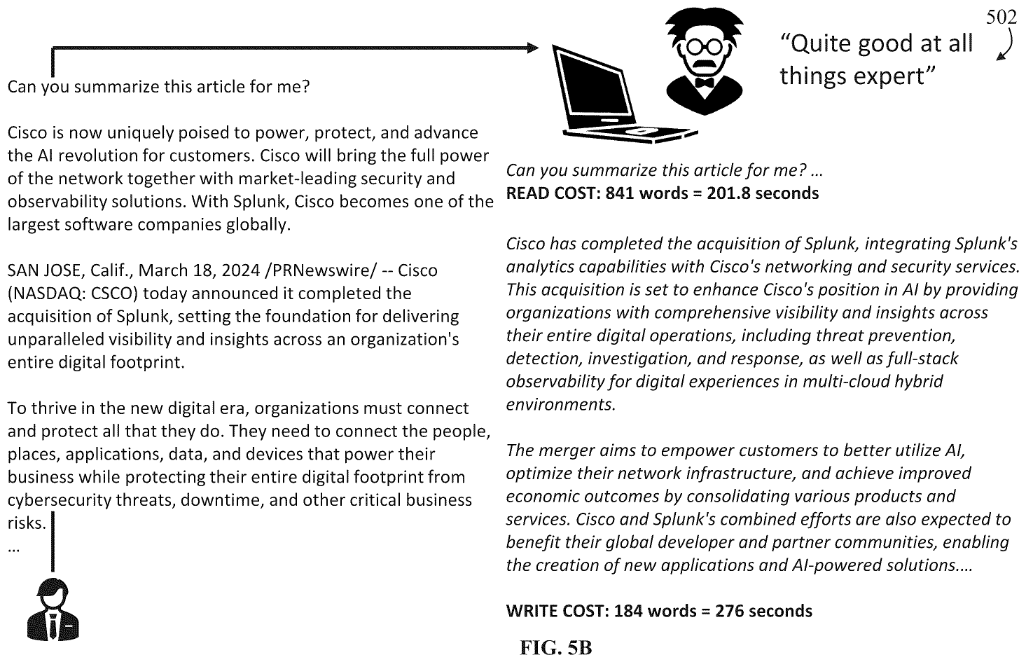

FIGS. 5A-5B illustrate an example of first scenario 500 and a second scenario 502 whereby a human expert is able to perform certain tasks at a measurable rate or within a certain amount of time, in accordance with one or more implementations described herein. Within these scenarios, if it is assumed that the output of an enterprise AI chat (e.g., generative AI) is the same as the “Quite good at all things expert,” what is the ROI? The input and output cost each prompt to an Enterprise AI Chat can be linked to the time saved thanks to “Quite good at all things expert.” This ROI can be in terms of the time savings, although the system can also use this to compute the amount of monetary savings, as well.

In the first scenario 500, an ROI may be calculated as:

$$Expert Time = read ( 1.2 s ) + write ( 672 s ) = 673.2 s$$

$$AI Cost = input ( 6 tokens ) + output ( 586 tokens ) = \$0 {\text{.0176}}^{*}$$

$$ROI = \$0 \text{.0176} saved 673.2 seconds ( more than 11 min . ) .$$

In the second scenario 502, an ROI may be calculated as:

$$Expert Cost = read ( 201.8 s ) + write ( 276 s ) = 477.8 s$$

$$AI Cost = input ( 1074 tokens ) + output ( 236 tokens ) = \$0 {\text{.0178}}^{*}$$

$$ROI = \$0 \text{.0178} saved 477.8 seconds ( about 8 min . ) .$$

Time-saved may be a valuable metric but can be hard to estimate given the wide variety of prompt and task types. An alternative may be to calculate the amount of time it would have taken an expert to receive, understand, and complete the task in the prompt, and calculate ROI as a function of not having to have hired that expert. That is, beyond the described examples of ROI calculations, ROI may alternatively or additionally be calculated based on estimating the steps a user would need to take without access to the LLM/Expert.

In various implementations, estimating the time saved can be considered a function of any of the following, or a combination thereof:
Read time (e.g., two hundred and fifty words per minute) to process the prompt as input,
Write time (e.g., forty words per minute) to craft the output to the prompt,
Thinking or searching time needed to retrieve the information to answer a query.

Other functions (e.g., time to test generated software, time to review the generated text, time to create an image, etc.) may be, additionally or alternatively, be included as well. However, simply counting the words in the input to an LLM as the “read” time and the words in the output as the “write” time to estimate the time saved may not accurately consider the attributes of the prompt itself.

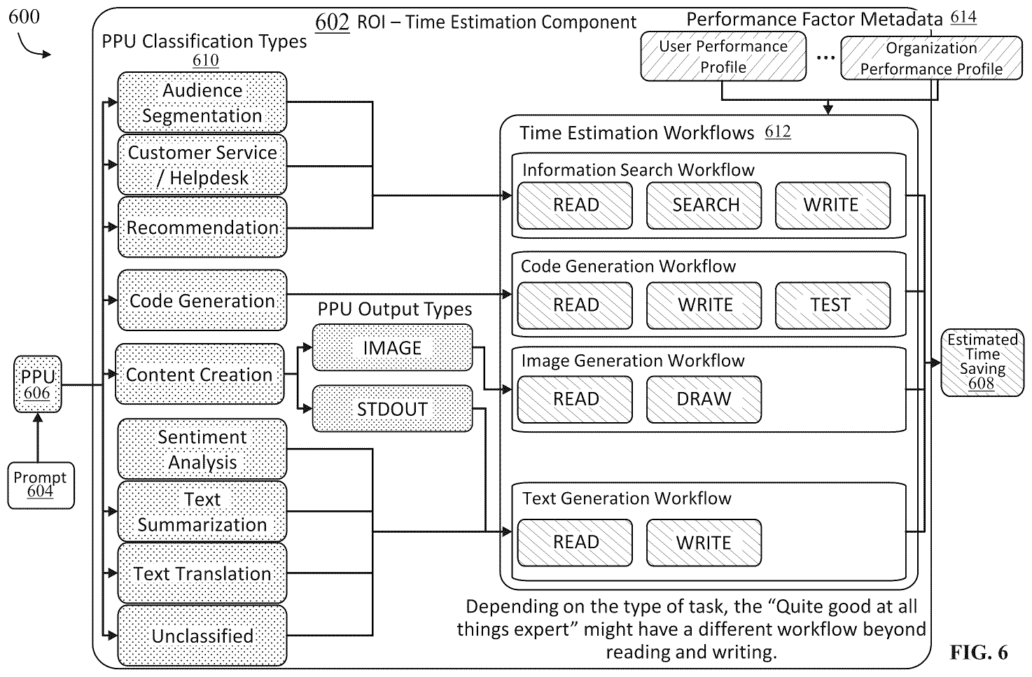

FIG. 6 illustrates an architecture 600 configured to generate ROI estimations using PPUs. As shown, time estimation component 602 may take as input the metadata extracted by a PPU 606 from a prompt 604 and output an estimated time saving 608. To do so, time estimation component 602 may first assess the type of task associated with prompt 604 based on its metadata. For instance, PPU 606 may indicate that the task associated with prompt 604 falls into one of the PPU classification types 610 shown.

For instance, prompt 604 may attempt to perform one of the following tasks:
audience segmentation
customer service/helpdesk tasks
making a recommendation
code generation
content creation
sentiment analysis
text summarization
text translation
etc.

In some cases, the task may also be unclassified, if it does not fit into any of the other PPU classification types 610. Depending on the specific classification of prompt 604, time estimation component 602 may select an appropriate time estimation workflow from among time estimation workflows 612 with which to determine estimated time saving 608. For instance, time estimation workflows 612 may include any or all of the following:
Information search workflow
Code generation workflow
Image generation workflow
Text generation workflow
etc.

In some cases, even a specific type of task, such as content creation, may be routed to a specific workflow based on its expected output. For instance, if prompt 604 is expected to result in the output of an image, time estimation component 602 may use the image generation workflow. Otherwise, it may use the text generation workflow, instead.

To compute estimated time saving 608, time estimation component 602 may determine one or more performance metrics associated with the workflow selected for prompt 604. In turn, time estimation component 602 may then compare the one or more performance metrics to one or more performance metrics computed using performance factor metadata 614. For instance, performance factor metadata 614 may include user performance profile information, organization-level performance profile information, etc.

By way of example, performance factor metadata 614 may indicate the amount of time that a particular programmer may take to read, write, and test a certain type of code. In turn, time estimation component 602 may compare the estimated amount of time for an LLM to process prompt 604, generate the requested code, and then test it. By comparing the two, time estimation component 602 can output estimated time saving 608 for that particular programmer.

In addition, time estimation component 602 may also adjust its estimates for different personas or roles within time estimation workflows 612 based on performance factor metadata 614. For instance, a text translation role might have a faster read and write time than a text summarization role.

By providing estimated time saving 608 to a user interface, the corresponding user can decide whether a given task within the organization is worth being handled with the help of an LLM or simply assigning that task to a particular person or set of people. In addition, this allows interested parties to track the utility of the LLM tools within the organization over time.

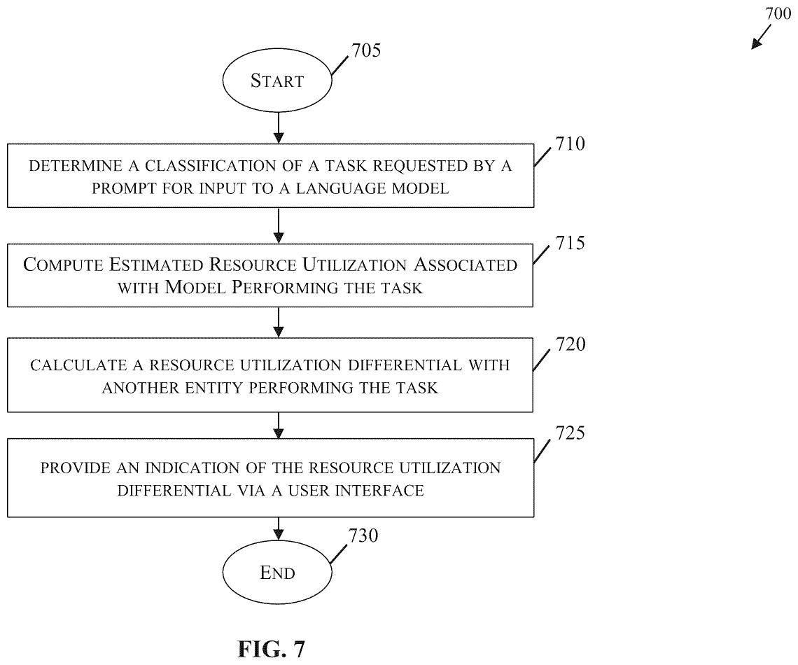

FIG. 7 illustrates an example simplified procedure generating PPU-based ROI estimations, in accordance with one or more implementations described herein. For example, a non-generic, specifically configured device (e.g., device 200), may perform procedure 700 (e.g., a method) by executing stored instructions (e.g., ROI process 248). The procedure 700 may start at step 705, and continues to step 710, where, as described in greater detail above, the device (e.g., a controller, processor, etc.) may determine a classification of a task requested by a prompt for input to a language model. For example, the prompt may be parsed to generate a prompt characterization. The prompt characterization may include a task requested in the prompt. The classification of the task requested in the prompt may be based on an analysis of the prompt characterization. In various implementations, the classification of the task requested by the prompt may be based on a determination of an output associated with the language model performing the task.

At step 715, as detailed above, a device may compute, based on the classification of the task, an estimated resource utilization associated with the language model performing the task. The estimated resource utilization may be an estimation of an amount of time associated with the language model performing the task, a cost associated with the language model performing the task, etc.

At step 720, as detailed above, a device may calculate a resource utilization differential between the estimated resource utilization and a resource utilization associated with another entity performing the task instead of the language model. In various implementations, the other entity performing the task may be a human user manually performing the task. Parameters of the manual performance of the task by the human user may be defined utilizing a user performance profile associated with the prompt and/or utilizing an organizational performance profile associated with the prompt.

The resource utilization differential may be based on at least one of an estimated amount of time associated with the language model performing the task and/or an estimated amount of time associated with the entity performing the task instead of the language model. Additionally, or alternatively, the resource utilization differential may be based on at least one of an estimated cost associated with the language model performing the task or an estimated cost associated with the entity performing the task instead of the language model.

At step 725, as detailed above, the device may provide an indication of the resource utilization differential via a user interface. The indication of the resource utilization differential may be provided as an estimated return-on-investment realized by the language model performing the task versus the entity performing the task instead of the language model.

Procedure 700 then ends at step 730.

It should be noted that while certain steps within procedure 700 may be optional as described above, the steps shown are merely examples for illustration, and certain other steps may be included or excluded as desired. Further, while a particular order of the steps is shown, this ordering is merely illustrative, and any suitable arrangement of the steps may be utilized without departing from the scope of the implementations herein.

The techniques described herein, therefore, introduce a mechanism that leverages a PPU to quantify and/or characterize, at a prompt level, ROIs and/or cost differentials between performing tasks by generative AI systems and/or alternative mechanisms. That is, the techniques introduce a mechanism by which ROI estimations (e.g., at a prompt-level) may be generated utilizing PPUs. These types of ROI insights may be utilized to improve decision making processes as they relate to generative AI utilization and/or be leveraged in decision making models tailored to enterprise-specific outcomes.

While there have been shown and described illustrative implementations that provide for ROI estimations using PPUs, it is to be understood that various other adaptations and modifications may be made within the spirit and scope of the implementations herein. For example, while certain implementations are described herein with respect to using certain elements, modules, components, architectures, etc. for the purposes of generating ROI estimations for generative AI use utilizing PPUs, the elements, modules, components, architectures, etc. are not limited as such and may be used for other functions, in other arrangements, in other functional distributions, in other implementations, etc.

In addition, while certain types of metadata and data types/categories such as tasks, sensitive data, policies, and outputs are shown, other suitable metadata and data types/categories, etc. may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as tangible, non-transitory, computer-readable medium having computer-executable instructions stored thereon that, when executed by a processor on a computer, cause the computer to perform a method.

For example, the components and/or elements may be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method, comprising:
determining, by a device, a classification of a task requested by a prompt for input to a language model;
computing, by the device and based on the classification of the task, an estimated resource utilization associated with the language model performing the task;
calculating, by the device, a resource utilization differential between the estimated resource utilization and a resource utilization associated with another entity performing the task instead of the language model; and
providing, by the device, an indication of the resource utilization differential via a user interface.

2. The method as in claim 1, wherein the classification of the task requested by the prompt is based on a determination of an output associated with the language model performing the task.

3. The method as in claim 1, wherein the resource utilization differential is based on at least one of an estimated amount of time associated with the language model performing the task or an estimated amount of time associated with the entity performing the task instead of the language model.

4. The method as in claim 1, wherein the entity performing the task is a human user manually performing the task.

5. The method as in claim 4, wherein parameters of a manual performance of the task by the human user are defined utilizing a user performance profile associated with the prompt.

6. The method as in claim 4, wherein parameters of a manual performance of the task by the human user are defined utilizing an organizational performance profile associated with the prompt.

7. The method as in claim 1, wherein the resource utilization differential is based on at least one of an estimated cost associated with the language model performing the task or an estimated cost associated with the entity performing the task instead of the language model.

8. The method as in claim 1, wherein the indication of the resource utilization differential is an estimated return-on-investment realized by the language model performing the task versus the entity performing the task instead of the language model.

9. The method as in claim 1, further comprising:
parsing the prompt to generate a prompt characterization, wherein the prompt characterization includes a task requested in the prompt.

10. The method as in claim 9, wherein the classification of the task requested in the prompt is based on an analysis of the prompt characterization.

11. An apparatus, comprising:
one or more network interfaces;
a processor coupled to the one or more network interfaces and configured to execute one or more processes; and
a memory configured to store a process that is executable by the processor, the process when executed configured to:
determine a classification of a task requested by a prompt for input to a language model;
compute, based on the classification of the task, an estimated resource utilization associated with the language model performing the task;
calculate a resource utilization differential between the estimated resource utilization and a resource utilization associated with another entity performing the task instead of the language model; and
provide an indication of the resource utilization differential via a user interface.

12. The apparatus as in claim 11, wherein the classification of the task requested by the prompt is based on a determination of an output associated with the language model performing the task.

13. The apparatus as in claim 11, wherein the resource utilization differential is based on at least one of an estimated amount of time associated with the language model performing the task or an estimated amount of time associated with the entity performing the task instead of the language model.

14. The apparatus as in claim 11, wherein the entity performing the task is a human user manually performing the task.

15. The apparatus as in claim 14, wherein parameters of a manual performance of the task by the human user are defined utilizing a user performance profile associated with the prompt.

16. The apparatus as in claim 14, wherein parameters of a manual performance of the task by the human user are defined utilizing an organizational performance profile associated with the prompt.

17. The apparatus as in claim 11, wherein the resource utilization differential is based on at least one of an estimated cost associated with the language model performing the task or an estimated cost associated with the entity performing the task instead of the language model.

18. The apparatus as in claim 11, wherein the indication of the resource utilization differential is an estimated return-on-investment realized by the language model performing the task versus the entity performing the task instead of the language model.

19. The apparatus as in claim 11, the process when executed further configured to:
parse the prompt to generate a prompt characterization, wherein the prompt characterization includes a task requested in the prompt; and
generate the classification of the task requested in the prompt based on an analysis of the prompt characterization.

20. A tangible, non-transitory, computer-readable medium storing program instructions that cause a device to execute a process comprising:
determining a classification of a task requested by a prompt for input to a language model;
computing, based on the classification of the task, an estimated resource utilization associated with the language model performing the task;
calculating a resource utilization differential between the estimated resource utilization and a resource utilization associated with another entity performing the task instead of the language model; and
providing an indication of the resource utilization differential via a user interface.
